(19) United States
(12) Patent Application Publication
(10) Pub. No.: US 2015/0058105 A1
(43) Pub. Date: Feb. 26, 2015

(54) SYSTEM AND METHOD FOR REWARDS CALCULATION

(71) Applicant: Capital One Financial Corporation, McLean, VA (US)

(72) Inventors: Hugo FONSECA, Richmond, VA (US); Rajsaday DUTT, Vienna, VA (US); Arya KALLA, Glen Allen, VA (US); Kevin C. ROSE, Richmond, VA (US)

(21) Appl. No.: 14/464,782

(22) Filed: Aug. 21, 2014

Related U.S. Application Data
(60) Provisional application No. 61/868,923, filed on Aug. 22, 2013.

(51) Int. Cl. G06Q 30/02

(52) U.S. Cl. CPC G06Q 30/0215; G06Q 30/0226
USPC 705/14.17

(57) ABSTRACT

A system and method in accordance with example embodiments may include systems and methods for calculating rewards, which may include, receiving account holder data, parsing the account holder data for transformation and loading purposes; receiving new financial account data from financial institutions, where a new financial account may be, for example, a credit card account, and new financial account data may include, for example, the terms and conditions associated with the financial account, fees associated with the financial account, and/or deals, benefits, rewards, and/or promotions associated with the financial account; determining spend categories based on the new financial account data; determining account holder customizations; determining seasonal trends associated with the account holder data; and determining an optimal new financial account based on the account holder data, new financial account data, spend categories, seasonal trends, and/or account holder customizations.

### CROSS-REFERENCE TO RELATED APPLICATIONS

This application contains subject matter related to and claims the benefit of U.S. Provisional Patent Application No. 61/868,923, filed on Aug. 22, 2013, the entire contents of which is incorporated herein by reference.

### FIELD OF THE DISCLOSURE

The present disclosure relates to systems and methods for calculating rewards for various financial accounts.

### BACKGROUND OF THE DISCLOSURE

Current systems and methods for detailing rewards and benefits associated with a particular financial account are impersonal and often misleading. Various types of financial accounts advertise deals, benefits, rewards, and/or promotions associated with the account. However, understanding how those deals, benefits, rewards, and/or promotions affect the account holder and which type of financial account would be best suited for the account holder can be difficult. These and other drawbacks exist.

### SUMMARY OF THE DISCLOSURE

Various embodiments of the present disclosure provide systems and methods for calculating rewards associated with a financial account. In an example embodiment, a method for calculating rewards may include, receiving account holder data, parsing the account holder data for transformation and loading purposes; receiving new financial account data from financial institutions, where a new financial account may be, for example, a credit card account, and new financial account data may include, for example, the terms and conditions associated with the financial account, fees associated with the financial account, and/or deals, benefits, rewards, and/or promotions associated with the financial account; determining spend categories based on the new financial account data; determining account holder customizations; determining seasonal trends associated with the account holder data; and determining an optimal new financial account based on the account holder data, new financial account data, spend categories, seasonal trends, and/or account holder customizations.

The method may further include receiving current transaction data to determine an optimal financial account based on the current transaction data.

### BRIEF DESCRIPTION OF THE DRAWINGS

Various embodiments of the present disclosure, together with further objects and advantages, may best be understood by reference to the following description taken in conjunction with the accompanying drawings, in the several figures of which like reference numerals identify like elements, and in which:

FIG. 1 depicts an example embodiment of a rewards calculation system;

FIG. 2 depicts an example embodiment of various modules used within the rewards calculation system;

FIG. 3 depicts an example embodiment of a rewards calculation method for determining an optimal new financial account;

FIG. 4 depicts an example embodiment of a rewards calculation method for determining an optimal financial account;

FIG. 5 depicts an example embodiment of a point of sale system;

FIG. 6 depicts an example embodiment of an authorization network; and

FIG. 7 depicts an example embodiment of a rewards calculation system;

### DETAILED DESCRIPTION OF THE EMBODIMENTS

The following description is intended to convey a thorough understanding of the embodiments described by providing a number of specific example embodiments and details involving systems and methods calculating rewards associated with a financial account. It should be appreciated, however, that the present disclosure is not limited to these specific embodiments and details, which are examples only. It is further understood that one possessing ordinary skill in the art, in light of known systems and methods, would appreciate the use of the invention for its intended purposes and benefits in various embodiments, depending on specific design and other needs. A financial institution and system supporting a financial institution are used as examples for the disclosure. The disclosure is not intended to be limited to financial institutions only.

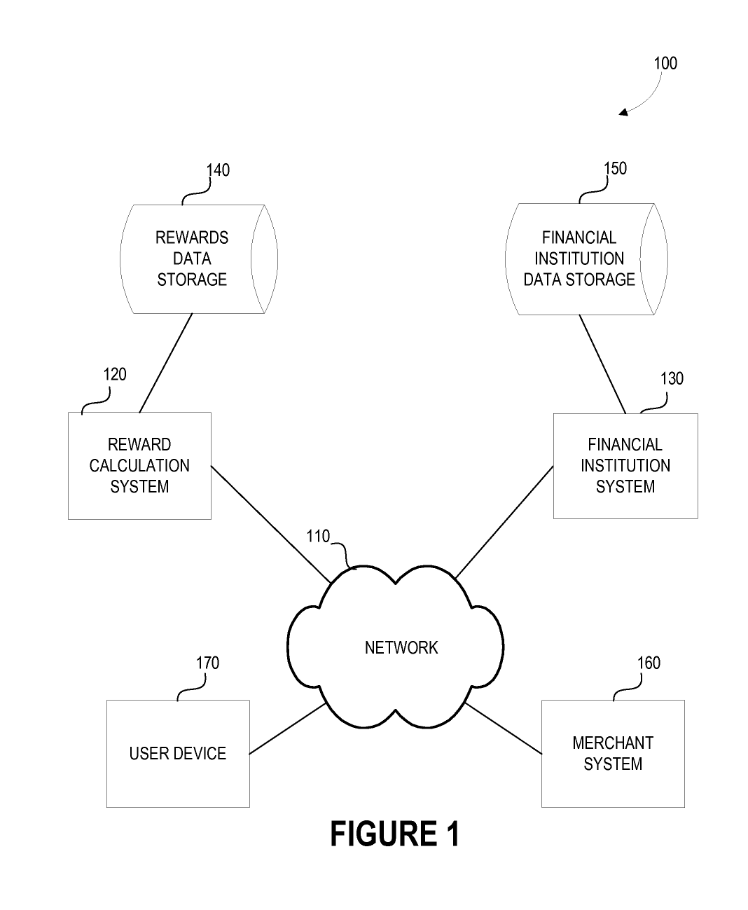

According to the various embodiments of the present disclosure, systems and methods enable calculating rewards associated with a financial account. The systems and methods depicted in FIGS. 1 through 4 provide optimization of deals, benefits, rewards, and/or promotions for a specific account holder based on at least account holder data and new financial account data. In addition to account holder data and new financial account data, the optimization may also be based on seasonal trends, user-customizations, such as a user indicating an upcoming life event or indicating previous purchases were due to a previous life event, and/or current transaction data.

In determining a method of payment with optimal deals, benefits, rewards, and/or promotions, calculations may be used based on account holder data and new financial account data. Account holder data may include account holder name, age, gender, home address, home telephone number, occupation, work address, work telephone number, household income, salary, and identification number, such as a social security number. Account holder data may also include transaction data for purchase history; which may include for example, merchant name, merchant location, merchant category, transaction amount, transaction details, and transaction date; other account debits; account credits, account balance; and/or other account-related data. New financial account data may include data associated with a new financial account, which may include, a credit card account, a prepaid card account, stored value card account, debit card account, check card account, payroll card account, gift card account, prepaid credit card account, charge card account, checking account, line of credit account, credit account, mobile device account, an account or service that links to an underlying payment account already described, or mobile commerce account. Each type of account may be associated with a financial institution. A financial institution may be, for example, a bank, other type of financial institution, including a credit card provider, for example, or any other entity that offers accounts to customers. An account may or may not have an associated card, such as, for example, a credit card for a credit account or a debit card for a debit account. The account may enable payment using biometric authentication, or contactless based forms of authentication, such as QR codes or near-field communications.

The new financial account data may include, for example, terms and conditions associated with the new financial account, additional fees associated with the new financial account, and/or deals, benefits, rewards, and/or promotions associated with new financial account. Terms and conditions may include a minimum balance, a maximum balance, a late payment fee, an overlimit fee, a foreign transaction fee, a cash advance fee, balance transfer fee, an annual percentage rate (APR) for purchases, an APR for balance transfers, an APR for cash advances, an APR for overdraft protection advances, and/or a minimum interest charge. Additional fees may include, for example, annual fees, monthly fees, and/or other account fees. Deals, benefits, rewards, and/or promotions may include, for example, reward category, reward point allocation by category, reward category cap, reward expiration data, deal category, deal expiration data, benefit category, benefit expiration data, promotion category, and/or promotion expiration data.

FIG. 1 depicts an example system 100 for use with rewards calculation for determining an optimal financial account. The system 100 may include a rewards data storage 140, a rewards calculation system 120, a financial institution system 130, and a financial institution data storage 150, where the rewards calculation system 120 and the financial institution system 130 may be connected over a network 110. Additionally, the system 100 may include a merchant system 160 and a user device 170, which may also be connected to the network 110.

Network 110 may be one or more of a wireless network, a wired network or any combination of wireless network and wired network. For example, network 110 may include one or more of a fiber optics network, a passive optical network, a cable network, an Internet network, a satellite network, a wireless LAN, a Global System for Mobile Communication (“GSM”), a Personal Communication Service (“PCS”), a Personal Area Network (“PAN”), Wireless Application Protocol (WAP), Multimedia Messaging Service (MMS), Enhanced Messaging Service (EMS), Short Message Service (SMS), Time Division Multiplexing (TDM) based systems, Code Division Multiple Access (CDMA) based systems, D-AMPS, Wi-Fi, Fixed Wireless Data, IEEE 802.11b, 802.15.1, 802.11n and 802.11g or any other wired or wireless network for transmitting and receiving a data signal.

In addition, network 110 may include, without limitation, telephone lines, fiber optics, IEEE Ethernet 902.3, a wide area network (“WAN”), a local area network (“LAN”), or a global network such as the Internet. In addition, network 110 may support an Internet network, a wireless communication network, a cellular network, or the like, or any combination thereof. Network 110 may further include one network, or any number of the example types of networks mentioned above, operating as a stand-alone network or in cooperation with each other. Network 110 may utilize one or more protocols of one or more network elements to which they are communicatively coupled. Network 110 may translate to or from other protocols to one or more protocols of network devices. Although network 110 is depicted as a single network, it should be appreciated that according to one or more embodiments, network 110 may comprise a plurality of interconnected networks, such as, for example, the Internet, a service provider's network, a cable television network, corporate networks, such as credit card association networks, and home networks.

A reward calculation system 120, a financial institution system 130, and a merchant system 160 may each include a network-enabled computer system and/or device. As referred to herein, a network-enabled computer system and/or device may include, but is not limited to: e.g., any computer device, or communications device including, e.g., a server, a network appliance, a personal computer (PC), a workstation, a mobile device, a phone, a handheld PC, a personal digital assistant (PDA), a thin client, a fat client, an Internet browser, or other device. The network-enabled computer systems may execute one or more software applications to, for example, receive data as input from an entity accessing the network-enabled computer system, process received data, transmit data over a network, and receive data over a network. The network-enabled computer systems may further include data storage. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, or any other storage mechanism.

A merchant system 160 may further include a Point of Sale (PoS) device and a payment processing system. In various embodiments, a PoS may be any device that may receive payment instructions from, for example, a magnetic strip payment card, a secure chip technology payment card, an NFC communication device, or any other form of payment. PoS device may be for example, PoS devices made by VeriFone® and/or any other like devices. A PoS device may also be any device capable of receiving and transmitting payment and transaction information from any payment method. By way of example, payment options may include mobile contactless payments, remote electronic payments, magnetic strip payments, secure chip technology payments, person-to-person payments, and the like. In an example embodiment, a PoS device may be capable of utilizing standardized transmission protocols, for example but not by way of limitation, ISO/IEC 14443 A/B, ISO/IEC 18092, MiFare, FeliCa, tag/smartcard emulation, and the like. Also, a PoS device may be able to utilize transmission protocols and methods that are developed in the future using other frequencies or modes of transmission. A PoS device may also be backwards-compatible with existing payment techniques, for example RFID.

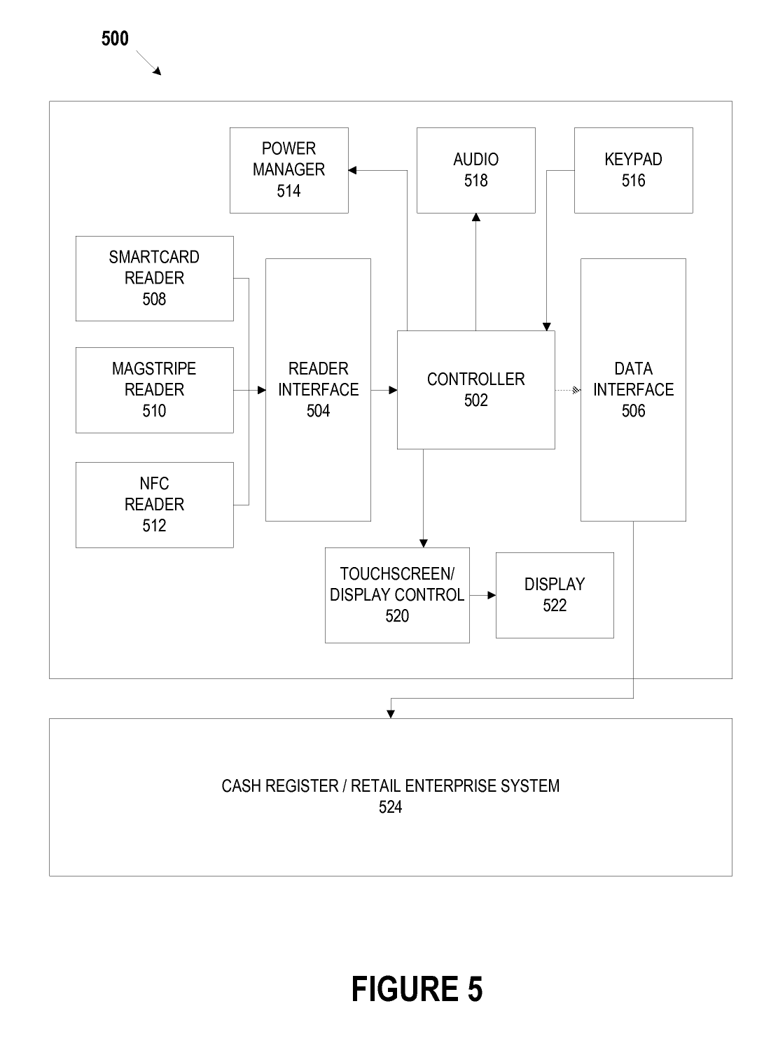

FIG. 5 depicts an example Point of Sale (PoS) device 500. PoS device 500 may provide the interface at what a customer or end user makes a payment to the merchant in exchange for goods or services. PoS device 500 may include and/or cooperate with weighing scales, scanners, electronic and manual cash registers, electronic funds transfer at point of sale (EFTPOS) terminals, touch screens and any other wide variety of hardware and software available for use with PoS device 500. PoS device 500 may be a retail point of sale system and may include a cash register and/or cash register-like computer components to enable purchase transactions. PoS device 500 also may be a hospitality point of sale system and include computerized systems incorporating registers, computers and peripheral equipment, usually on a computer network to be used in restaurant, hair salons, hotels or the like. PoS device 500 may be a wireless point of sale device similar to a PoS device described herein or, for example a tablet computer that is configured to operate as a PoS device, including for example, software to cause the tablet computer to execute point of sale functionality and a card reader such as for example the Capital One® SparkPay card reader, the Square® reader, Intuit's® GoPayment reader, or the like. PoS device 500 also may be a cloud-based point of sale system that can be deployed as software as a service, which can be accessed directly from the Internet using, for example, an Internet browser.

Referring to FIG. 5, an example PoS device 500 is shown. PoS device 500 may include a controller 502, a reader interface 504, a data interface 506, a smartcard reader 508, a magnetic stripe reader 510, a near-field communications (NFC) reader 512, a power manager 514, a keypad 516, an audio interface 518, a touchscreen/display controller 520, and a display 522. Also, PoS device 500 may be coupled with, integrated into or otherwise connected with a cash register/retail enterprise system 524.

In various embodiments, Controller 502 may be any controller or processor capable of controlling the operations of PoS device 500. For example, controller 502 may be a Intel® 2nd Generation Core™ i3 or i5 or Pentium™ G850 processor or the like. Controller 502 also may be a controller included in a personal computer, smartphone device, tablet PC or the like.

Reader interface 504 may provide an interface between the various reader devices associated with PoS device 500 and PoS device 500. For example, reader interface 504 may provide an interface between smartcard reader 508, magnetic stripe reader 510, NFC reader 512 and controller 502. In various embodiments, reader interface 504 may be a wired interface such as a USB, RS232 or RS485 interface and the like. Reader interface 504 also may be a wireless interface and implement technologies such as Bluetooth, the 802.11(x) wireless specifications and the like. Reader interface 504 may enable communication of information read by the various reader devices from the various reader devices to PoS device 500 to enable transactions. For example, reader interface 504 may enable communication of a credit or debit card number read by a reader device from that device to PoS device 500. In various embodiments, reader interface 504 may interface between PoS device 500 and other devices that do not necessarily “read” information but instead receive information from other devices.

Data interface 506 may allow PoS device 500 to pass communicate data throughout PoS device and with other devices including, for example, cash register/retail enterprise system 524. Data interface 506 may enable PoS device 500 to integrate with various customer resource management (CRM) and/or enterprise resource management (ERP) systems. Data interface 506 may include hardware, firmware and software that make aspects of data interface 506 a wired interface. Data interface 506 also may include hardware, firmware and software that make aspects of data interface 506 a wireless interface. In various embodiments, data interface 506 also enables communication between PoS device other devices.

Smartcard reader 508 may be any electronic data input device that reads data from a smart card. Smartcard reader 508 may be capable of supplying an integrated circuit on the smart card with electricity and communicating with the smart card via protocols, thereby enabling read and write functions. In various embodiments, smartcard reader 508 may enable reading from contact or contactless smart cards. Smartcard reader 508 also may communicate using standard protocols including ISO/IEC 7816, ISO/IEC 14443 and/or the like or proprietary protocols.

Magnetic stripe reader 510 may be any electronic data input device that reads data from a magnetic stripe on a credit or debit card, for example. In various embodiments, magnetic stripe reader 510 may include a magnetic reading head capable of reading information from a magnetic stripe. Magnetic stripe reader 510 may be capable of reading, for example, cardholder information from tracks 1, 2, and 3 on magnetic cards. In various embodiments, track 1 may be written on a card with code known as DEC SIXBIT plus odd parity and the information on track 1 may be contained in several formats (e.g., format A, which may be reserved for proprietary use of the card issuer; format B; format C-M which may be reserved for us by ANSI subcommittee X3B10; and format N-Z, which may be available for use by individual card issuers). In various embodiments, track 2 may be written with a 5-bit scheme (4 data bits plus 1 parity). Track 3 may be unused on the magnetic stripe. In various embodiments, track 3 transmission channels may be used for transmitting dynamic data packet information to further enable enhanced token-based payments.

NFC reader 512 may be any electronic data input device that reads data from a NFC device. In an exemplary embodiment, NFC reader 512 may enable Industry Standard NFC Payment Transmission. For example, the NFC reader 512 may communicate with a NFC enabled device to enable two loop antennas to form an air-core transformer when placed near one another by using magnetic induction. NFC reader 512 may operate at 13.56 MHz or any other acceptable frequency. Also, NFC reader 512 may enable a passive communication mode, where an initiator device provides a carrier field, permitting answers by the target device via modulation of existing fields. Additionally, NFC reader 512 also may enable an active communication mode by allowing alternate field generation by the initiator and target devices.

In various embodiments, NFC reader 512 may deactivate an RF field while awaiting data. NFC reader 512 may receive communications containing Miller-type coding with varying modulations, including 100% modulation. NFC reader 512 also may receive communications containing Manchester coding with varying modulations, including a modulation ratio of approximately 10%, for example. Additionally, NFC reader 512 may be capable of receiving and transmitting data at the same time, as well as checking for potential collisions when the transmitted signal and received signal frequencies differ.

NFC reader 512 may be capable of utilizing standardized transmission protocols, for example but not by way of limitation, ISO/IEC 14443 A/B, ISO/IEC 18092, MiFare, FeliCa, tag/smartcard emulation, and the like. Also, NFC reader 512 may be able to utilize transmission protocols and methods that are developed in the future using other frequencies or modes of transmission. NFC reader 512 also may be backwards-compatible with existing payment techniques, such as, for example RFID. Also, NFC reader 512 may support transmission requirements to meet new and evolving payment standards including internet based transmission triggered by NFC. In various embodiments, NFC reader 512 may utilize MasterCard's® PayPass and/or Visa's® PayWave and/or American Express′® ExpressPay systems to enable transactions.

Although not shown and described, other input devices and/or readers, such as for example, barcode readers and the like are contemplated.

Power manager 514 may be any microcontroller or integrated circuit that governs power functions of PoS device 500. Power manager 514 may include, for example, firmware, software, memory, a CPU, a CPU, input/output functions, timers to measure intervals of time, as well as analog to digital converters to measure the voltages of the main battery or power source of PoS device 500. In various embodiments, Power manager 514 remain active even when PoS device 500 is completely shut down, unused, and/or powered by the backup battery. Power manager 514 may be responsible for coordinating many functions, including, for example, monitoring power connections and battery charges, charging batteries when necessary, controlling power to other integrated circuits within PoS device 500 and/or other peripherals and/or readers, shutting down unnecessary system components when they are left idle, controlling sleep and power functions (on and off), managing the interface for built-in keypad and trackpads, and/or regulating a real-time clock (RTC).

Keypad 516 may any input device that includes a set of buttons arranged, for example, in a block or pad and may bear digits, symbols and/or alphabetical letters. Keypad 516 may be a hardware-based or mechanical-type keypad and/or implemented in software and displayed on, for example, a screen or touch screen to form a keypad. Keypad 516 may receive input from a user that pushed or otherwise activates one or more buttons on keypad 516 to provide input.

Audio interface 518 may be any device capable of providing audio signals from PoS device 500. For example, audio interface may be a speaker or speakers that may produce audio signals. In various embodiments, audio interface 518 may be integrated within PoS device 500. Audio interface 518 also may include components that are external to PoS device 500.

Touchscreen/display control 520 may be any device or controller that controls an electronic visual display. Touchscreen/display control 520 may allow a user to interact with PoS device 500 through simple or multi-touch gestures by touching a screen or display (e.g., display 522). Touchscreen/display control 520 may be configured to control any number of touchscreens, including, for example, resistive touchscreens, surface acoustic wave touchscreens, capacitive touchscreens, surface capacitance touchscreens, projected capacitance touchscreens, mutual capacitance touchscreens, self-capacitance touchscreens, infrared grid touchscreens, infrared acrylic projection touchscreens, optical touchscreens, touchscreens based on dispersive signal technology, acoustic pulse recognition touchscreens, and the like. In various embodiments, touchscreen/display control 520 may receive inputs from the touchscreen and process the received inputs. Touchscreen/display control 520 also may control the display on PoS device 500, thereby providing the graphical user interface on a display to a user of PoS device 500.

Display 522 may be any display suitable for a PoS device. For example, display 522 may be a TFT, LCD, LED or other display. Display 522 also may be a touchscreen display that for example allows a user to interact with PoS device 500 through simple or multi-touch gestures by touching a screen or display (e.g., display 522). Display 522 may include any number of touchscreens, including, for example, resistive touchscreens, surface acoustic wave touchscreens, capacitive touchscreens, surface capacitance touchscreens, projected capacitance touchscreens, mutual capacitance touchscreens, self-capacitance touchscreens, infrared grid touchscreens, infrared acrylic projection touchscreens, optical touchscreens, touchscreens based on dispersive signal technology, acoustic pulse recognition touchscreens, and the like. In various embodiments, 522 may receive inputs from control gestures provided by a user. Display 522 also may display images, thereby providing the graphical user interface to a user of PoS device 500.

Cash register/retail enterprise system 524 may me any device or devices that cooperate with PoS device 500 to process transactions. Cash register/retail enterprise system 524 may be coupled with other components of PoS device 500 via, for example, a data interface (e.g., data interface 506) as illustrated in FIG. 5. Cash register/retail enterprise system 524 also may be integrated into PoS device 500.

In various embodiments, cash register/retail enterprise system 524 may be a cash register. Example cash registers may include, for example, mechanical or electronic devices that calculate and record sales transactions. Cash registers also may include a cash drawer for storing cash and may be capable of printing receipts. Cash registers also may be connected to a network to enable payment transactions. Cash registers may include a numerical pad, QWERTY or custom keyboard, touch screen interface, or a combination of these input methods for a cashier to enter products and fees by hand and access information necessary to complete the sale.

In various embodiments, cash register/retail enterprise system 524 may comprise an retail enterprise system and/or a customer relationship management system. Retail enterprise system 524 may enable retain enterprises to manage operations and performance across a retail operation. Retail enterprise system 524 may be a stand-alone application in, for example, individual stores, or may be interconnected via a network. Retail enterprise system 524 may include various point of sale capabilities, including the ability to, for example, customize and resize transaction screens, work with a “touch screen” graphical user interface, enter line items, automatically look up price (sales, quantity discount, promotional, price levels), automatically compute tax, VAT, look up quantity and item attribute, display item picture, extended description, and sub-descriptions, establish default shipping services, select shipping carrier and calculate shipping charges by weight/value, support multi-tender transactions, including cash, check, credit card, and debit card, accept food stamps, place transactions on hold and recall, perform voids and returns at POS, access online credit card authorizations and capture electronic signatures, integrate debit and credit card processing, ensure optional credit card discounts with address verification, support mix-and-match pricing structure, discount entire sale or selected items at time of sale, add customer account, track customer information, including total sales, number of visits, and last visit date, issue store credit, receive payment(s) for individual invoices, process deposits on orders, search by customer's ship-to address, create and process layaway, back orders, work orders, and sales quotes, credit items sold to selected sales reps, view daily sales graph at the PoS, view and print journals from any register, preview, search, and print journals by register, batch, and/or receipt number, print X, Z, and ZZ reports, print receipts, invoices, and pick tickets with logos/graphics, print kit components on receipt, reprint receipts, enter employee hours with an integrated time clock function, and/or sell when the network/server is down with an offline PoS mode. Retail enterprise system 524 also may include inventory control and tracking capabilities, reporting tools, customer management capabilities, employee management tools, and may integrate with other accounting software.

In various embodiments cash register/retail enterprise system 524 may be a hospitality PoS. In such embodiments, retail enterprise system 524 may include hospitality PoS software (e.g, Aloha PoS Restaurant software from NCR®, Micros® RES and Symphony software and the like), hospitality management software, and other hardware and software to facilitate hospitality operations.

Referring back to FIG. 1, the system may support transmission requirements to meet new and evolving payment standards including internet based transmission triggered by NFC. Payment processing system may allow merchant to request and process payments, for example. Payment processing system may utilize network to communicate payment requests to financial institution or account provider and receive authorization requests. In communicated payment requests, payment processing system may transmit information to a financial institution and/or an account provider system using, for example, networks maintained by Visa®, MasterCard®, Discover®, American Express® and the like.

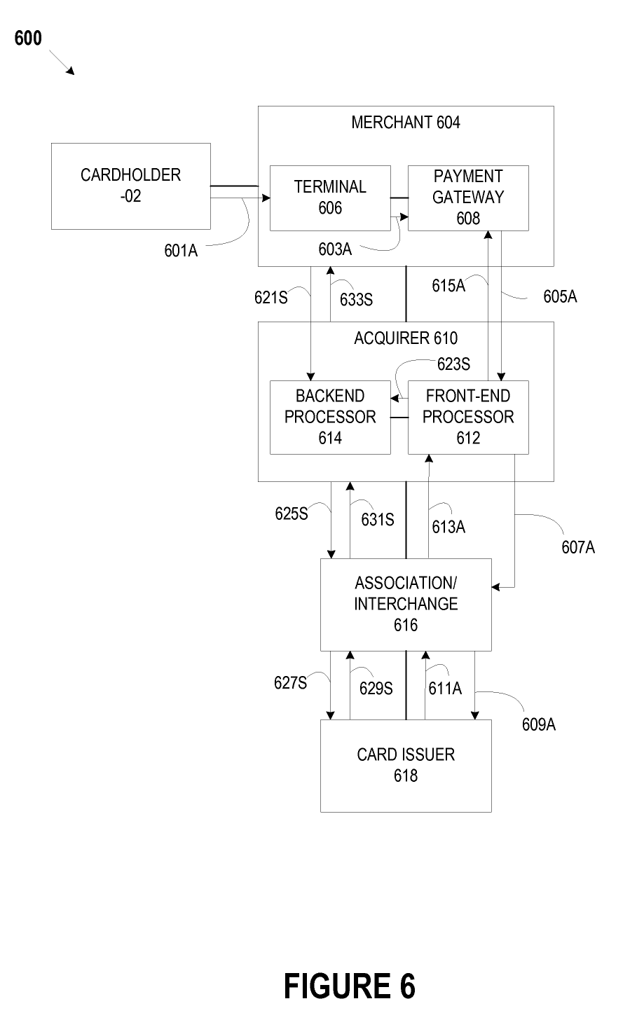

FIG. 6 illustrates an example system 600 and method for card authorization. As shown and described in FIG. 6, merchants, cardholders and financial institutions may be connected with a card association network to enable secure transactions and timely payments. System 600 may include a cardholder 602, merchant 604, Acquirer 610, Association/Interchange 616, and card issuer 618.

Cardholder 602 may be any card holder, including a credit card holder, debit card holder, stored value card holder and the like. Cardholder 602 may possess a plastic card or carry a device (e.g., a mobile device) that securely stores card credentials and is capable of transmitting the card credentials to, for example, a PoS terminal (e.g., terminal 606). Cardholder 602 may interact with a merchant (e.g., merchant 604) by presenting a card or card credentials to a terminal (e.g., terminal 606).

Merchant 604 may be any merchant that accepts payment from a cardholder, for example. Merchant 604 may be any retailer, service provider, business entity, or individual that accepts payments. Merchant 604 may include software, firmware and hardware for accepting and/or processing payments. For example, as illustrated in FIG. 6, merchant 604 may include a terminal 606 and a payment gateway 608. Terminal 606 and payment gateway 608 may comprise the physical or virtual device(s) used by merchant 604 to communicate information to front-end processor 612 of acquirer 610. Terminal 606 may be similar to PoS system [Y00] as shown and described in Figure Y. In various embodiments, payment gateway 608 may be an e-commerce application service provider service that authorizes payments for merchants. As such, payment gateway 608 may be a virtual equivalent of a PoS terminal and interface with, for example, a billing system of merchant 604 and pass data to front-end processor 612 of acquirer 610.

Acquirer 610 may be, for example, a financial institution or bank, that holds the contract for providing payment processing services to merchant 604. Merchant 604 may have a merchant account that may serve as a contract under which Acquirer 610 may extend a line of credit to a merchant who wishes to accept, for example, credit card transactions. As shown in FIG. 6, Acquirer 610 may be associated with front-end processor 612 and back-end processor 614.

In various examples, front-end processor 612 may be a platform that card terminal 606 and/or payment gateway 608 communicate with when approving a transaction. Front-end processor 612 may include hardware, firmware, and software to process transactions. Front-end processor 612 may be responsible for the authorization and capture portion of credit card transaction. Front-end processor 612 also may include additional front-end platform interconnections to support, for example, ACH and debit transactions.

Backend processor 614 may be a platform that takes captured transactions from front-end processor 612 and settles them through an Interchange system (e.g., association/interchange 616). Back-end processor 614 may generate, for example, daily ACH files for merchant settlement. Back-end processor 614 also may handle chargeback handling, retrieval request and monthly statements.

Association/interchange 616 may be the consumer payment system whose members are the financial institutions that issue payment cards and/or sign merchant to accept payment cards. Example associations/interchanges 616 may include, Visa®, MasterCard®, and AmericanExpress®. Association/interchange 616 may include one or more computer systems and networks to process transactions.

Issuer 618 may be a financial institution that issues payment cards and maintains a contract with cardholders for repayment. In various embodiments, issuer 618 may issue credit, debit, and/or stored value cards, for example. Example issuers may include, Capital One, Bank of America, Citibank, and the like.

In various embodiments, processing a payment card transaction may involves two stages: (1) authorization and (2) clearing and settlement. Authorization may refer to an electronic request that is sent through various parties to either approve or decline the transaction. Clearing and Settlement may refer to settlement of the parties' settle accounts to enable the parties to get paid.

During authorization, cardholder 602 may present payment card as payment (601A) at merchant 604 PoS terminal 606, for example. Merchant 604 may enter card into a physical PoS terminal 606 or submit a credit card transaction to a payment gateway 608 on behalf of cardholder 602 via secure connection from a Web site, retail location, or a wireless device.

Payment gateway 608 may receive the secure transaction information (603A) and may pass the secure transaction information (605A) via a secure connection to the merchant acquirer's 610 front-end processor 612.

Front-end processor 612 may submit the transaction (607A) to association/interchange 616 (e.g., a network of financial entities that communicate to manage the processing, clearing and settlement of credit card transactions). Association/interchange 616 may route the transaction (609A) to the customer's Issuer 618. Issuer 618 may approve or decline the transaction and passes the transaction results back (611A) through association/interchange 616. Association/interchange then may relay the transaction results (613A) to front-end processor 612.

Front-end processor 612 may relay the transaction results (615A) back to the payment gateway 608 and/or terminal 606. Payment gateway 608 may store the transaction results and sends them to merchant 604. Merchant 604 may receive the authorization response and complete the transaction accordingly.

During settlement, merchant 604 may deposit the transaction receipt (621S) with acquirer 610 via, for example, a settlement batch. Captured authorizations may be passed (623S) from front-end processor 612 to the back-end processor 614 for settlement. Back-end processor may generates ACH files for merchant settlement. Acquirer may submit settlement files (625S, 627S) to Issuer 618 for reimbursement via association/interchange 616. Issuer 618 may post the transaction and pay merchant 604 (629S, 631S, 633S).

Referring back to FIG. 1, merchant system 160 may include a module device capable of executing a payment and/or receiving notifications from an account provider. For example, a mobile device could be an iPhone, iPod, iPad from Apple® or any other mobile device running Apple's iOS operating system, any device running Google's Android® operating system, any device running Microsoft's Windows® Mobile operating system, and/or any other smartphone or like device.

User device 170 may include a personal computing device, such as a smartphone or tablet, and/or personal computer. For example, user device 170 could be an iPhone, iPod, iPad from Apple® or any other device running Apple's iOS operating system, any device running Google's Android® operating system, any device running Microsoft's Windows® Mobile operating system, and/or any other smartphone or like device.

User device 170 may include for example, a Subscriber Identity Module (SIM) card, an NFC module, and an App Processor. The SIM card may be an integrated circuit that securely stores the service-subscriber key (IMSI) used to identify a subscriber on mobile telephony devices (such as mobile phones and computers). The NFC module may be an embedded NFC chip that can send encrypted data a short distance (“near field”) to a reader located, for instance, next to a retail cash register. The App Processor may enable execution of software applications on user device 170. In various embodiments, the app processor may cooperate with the NFC module to enable a payment using user device 170. Additionally, user device 170 may include an attachment for contactless payments (not shown), such as a contactless payment attachment that plugs into an audio jack or plug of a mobile device.

The App Processor of the user device 170 may enable determining an optimal new financial account, or determining an optimal financial account when user for a particular transaction as described with respect to FIG. 6. The user device 170, including an application and associated user interfaces, may leverage transaction data, wireless data connection, over-the-air data connection, or other means of data transmission. The data used in the application may be transmitted from external data sources, such as a rewards calculation system 120, a financial institution system 130, and/or a merchant system 160. For example, the application and user interface may leverage information about products and/or services being purchased, information about financial account(s) associated with the account holder, information about financial account(s) which are available for the account holder to apply for, and information about the account holder.

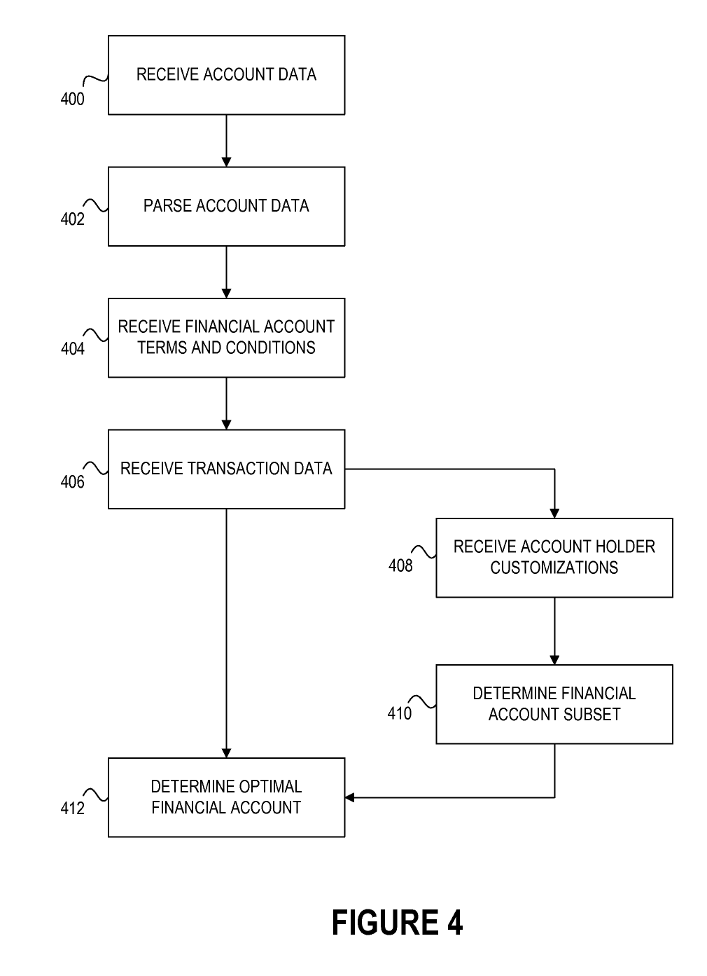

The user device 170 may also include various software components to facilitate determining an optimal new financial account. For example, user device 170 may include an operating system such as, for example, the iOS operating system from Apple, the Google Android operating system, and any version of the Windows operating system from Microsoft. User device 170 may also include, without limitation, software applications such as mobile banking applications to facilitate determining an optimal new financial account (or optimal account as described in FIG. 4), an NFC application programming interface, and software to enable touch sensitive displays. Mobile device manufacturers may provide software stacks (APIs) which allow software applications to be written on top of the software stacks. For example, mobile device manufacturers may provide, without limitation, a card emulation API to enable NFC card emulation mode, a logic link control protocol (LLCP) API for peer-to-peer communication between mobile devices, and a real-time data (RTD) API and a NFC Data Exchange Format (NDEF) API for reading/writing.

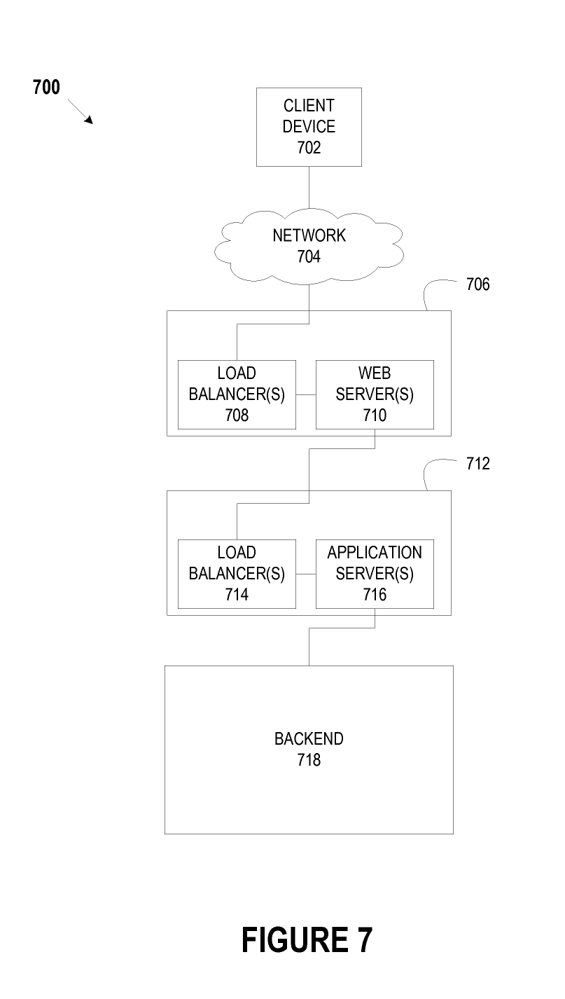

FIG. 7 illustrates a system 700 that may enable a user device to interact with a rewards calculation system, financial system and/or the like. For example, FIG. 7 depicts an example system 700 that may enable a rewards calculation system and/or financial institution, for example, to provide network services to its customers. As shown in FIG. 7, system 700 may include a client device 702, a network 704, a front-end controlled domain 706, a back-end controlled domain 712, and a backend 718. Front-end controlled domain 706 may include one or more load balancers 708 and one or more web servers 710. Back-end controlled domain 712 may include one or more load balancers 714 and one or more application servers 716.

Client device 702 may be a network-enabled computer: As referred to herein, a network-enabled computer may include, but is not limited to: e.g., any computer device, or communications device including, e.g., a server, a network appliance, a personal computer (PC), a workstation, a mobile device, a phone, a handheld PC, a personal digital assistant (PDA), a thin client, a fat client, an Internet browser, or other device. The one or more network-enabled computers of the example system 700 may execute one or more software applications to enable, for example, network communications.

Client device 702 also may be a mobile device: For example, a mobile device may include an iPhone, iPod, iPad from Apple® or any other mobile device running Apple's iOS operating system, any device running Google's Android® operating system, including for example, Google's wearable device, Google Glass, any device running Microsoft's Windows® Mobile operating system, and/or any other smartphone or like wearable mobile device.

Network 704 may be one or more of a wireless network, a wired network, or any combination of a wireless network and a wired network. For example, network 704 may include one or more of a fiber optics network, a passive optical network, a cable network, an Internet network, a satellite network, a wireless LAN, a Global System for Mobile Communication (GSM), a Personal Communication Service (PCS), a Personal Area Networks, (PAN), D-AMPS, Wi-Fi, Fixed Wireless Data, IEEE 802.11b, 802.15.1, 802.11n, and 802.11g or any other wired or wireless network for transmitting and receiving a data signal.

In addition, network 704 may include, without limitation, telephone lines, fiber optics, IEEE Ethernet 902.3, a wide area network (WAN), a local area network (LAN) or a global network such as the Internet. Also, network 704 may support an Internet network, a wireless communication network, a cellular network, or the like, or any combination thereof. Network 704 may further include one network, or any number of example types of networks mentioned above, operating as a stand-alone network or in cooperation with each other. Network 704 may utilize one or more protocols of one or more network elements to which they are communicatively couples. Network 704 may translate to or from other protocols to one or more protocols of network devices. Although network 704 is depicted as a single network, it should be appreciated that according to one or more embodiments, network 704 may comprise a plurality of interconnected networks, such as, for example, the Internet, a service provider's network, a cable television network, corporate networks, and home networks.

Front-end controlled domain 706 may be implemented to provide security for backend 718. Load balancer(s) 708 may distribute workloads across multiple computing resources, such as, for example computers, a computer cluster, network links, central processing units or disk drives. In various embodiments, load balancer(s) 710 may distribute workloads across, for example, web server(S) 716 and/or backend 718 systems. Load balancing aims to optimize resource use, maximize throughput, minimize response time, and avoid overload of any one of the resources. Using multiple components with load balancing instead of a single component may increase reliability through redundancy. Load balancing is usually provided by dedicated software or hardware, such as a multilayer switch or a Domain Name System (DNS) server process.

Load balancer(s) 708 may include software that monitoring the port where external clients, such as, for example, client device 702, connect to access various services of a financial institution, for example. Load balancer(s) 708 may forward requests to one of the application servers 716 and/or backend 718 servers, which may then reply to load balancer 708. This may allow load balancer(s) 708 to reply to client device 702 without client device 702 ever knowing about the internal separation of functions. It also may prevent client devices from contacting backend servers directly, which may have security benefits by hiding the structure of the internal network and preventing attacks on backend 718 or unrelated services running on other ports, for example.

A variety of scheduling algorithms may be used by load balancer(s) 708 to determine which backend server to send a request to. Simple algorithms may include, for example, random choice or round robin. Load balancers 708 also may account for additional factors, such as a server's reported load, recent response times, up/down status (determined by a monitoring poll of some kind), number of active connections, geographic location, capabilities, or how much traffic it has recently been assigned.

Load balancers 708 may be implemented in hardware and/or software. Load balancer(s) 708 may implement numerous features, including, without limitation: asymmetric loading; Priority activation: SSL Offload and Acceleration; Distributed Denial of Service (DDoS) attack protection; HTTP compression; TCP offloading; TCP buffering; direct server return; health checking; HTTP caching; content filtering; HTTP security; priority queuing; rate shaping; content-aware switching; client authentication; programmatic traffic manipulation; firewall; intrusion prevention systems.

Web server(s) 710 may include hardware (e.g., one or more computers) and/or software (e.g., one or more applications) that deliver web content that can be accessed by, for example a client device (e.g., client device 702) through a network (e.g., network 704), such as the Internet. In various examples, web servers, may deliver web pages, relating to, for example, online banking applications and the like, to clients (e.g., client device 702). Web server(s) 710 may use, for example, a hypertext transfer protocol (HTTP or sHTTP) to communicate with client device 702. The web pages delivered to client device may include, for example, HTML documents, which may include images, style sheets and scripts in addition to text content.

A user agent, such as, for example, a web browser, web crawler, or native mobile application, may initiate communication by making a request for a specific resource using HTTP and web server 710 may respond with the content of that resource or an error message if unable to do so. The resource may be, for example a file on stored on backend 718. Web server(s) 710 also may enable or facilitate receiving content from client device 702 so client device AO2 may be able to, for example, submit web forms, including uploading of files.

Web server(s) also may support server-side scripting using, for example, Active Server Pages (ASP), PHP, or other scripting languages. Accordingly, the behavior of web server(s) 710 can be scripted in separate files, while the actual server software remains unchanged.

Load balancers 714 may be similar to load balancers 708 as described above.

Application server(s) 716 may include hardware and/or software that is dedicated to the efficient execution of procedures (e.g., programs, routines, scripts) for supporting its applied applications. Application server(s) 716 may comprise one or more application server frameworks, including, for example, Java application servers (e.g., Java platform, Enterprise Edition (Java EE), the .NET framework from Microsoft®, PHP application servers, and the like). The various application server frameworks may contain a comprehensive service layer model. Also, application server(s) 716 may act as a set of components accessible to, for example, a financial institution or other entity implementing system 700, through an API defined by the platform itself. For Web applications, these components may be performed in, for example, the same running environment as web server(s) 710, and application servers 716 may support the construction of dynamic pages. Application server(s) 716 also may implement services, such as, for example, clustering, fail-over, and load-balancing. In various embodiments, where application server(s) 716 are Java application servers, the web server(s) 716 may behaves like an extended virtual machine for running applications, transparently handling connections to databases associated with backend 718 on one side, and, connections to the Web client (e.g., client device 702) on the other.

Backend 718 may include hardware and/or software that enables the backend services of, for example, a financial institution or other entity that maintains a distributes system similar to system 700. For example, backend 718 may include, a system of record, online banking applications, a rewards platform, a payments platform, a lending platform, including the various services associated with, for example, auto and home lending platforms, a statement processing platform, one or more platforms that provide mobile services, one or more platforms that provide online services, a card provisioning platform, a general ledger system, and the like. Backend 718 may be associated with various databases, including account databases that maintain, for example, customer account information, product databases that maintain information about products and services available to customers, content databases that store content associated with, for example, a financial institution, and the like. Backend 718 also may be associated with one or more servers that enable the various services provided by system 700.

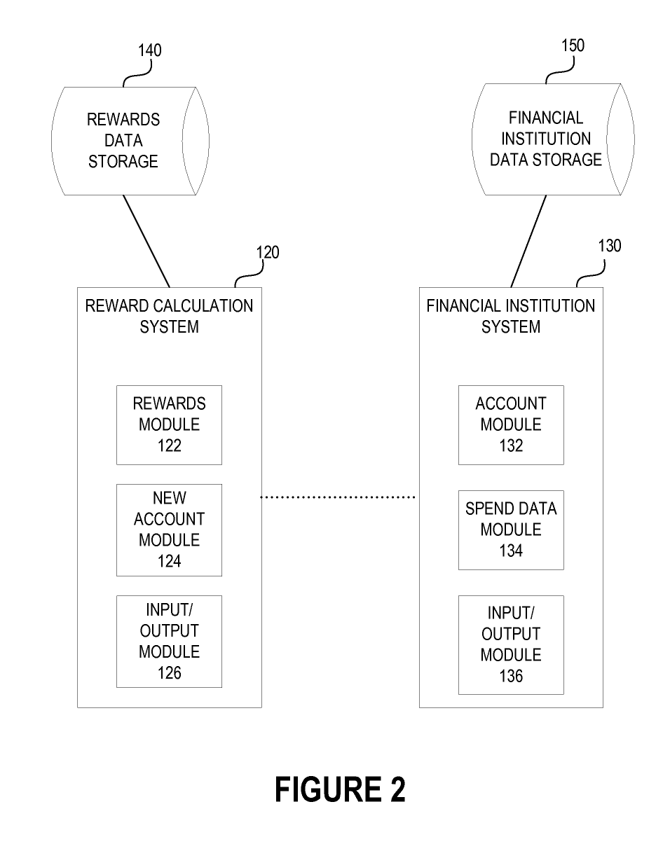

Referring now to FIG. 2, FIG. 2 illustrates various modules which may be used in conjunction with the rewards calculation system 120 and the financial institution system 130 to determine an optimal new financial account based on rewards calculation. As used herein, the term “module” may be understood to refer to computer executable software, firmware, hardware, or various combinations thereof. It is noted that the modules are examples. The modules may be combined, integrated, separated, or duplicated to support various applications. Also, a function described herein as being performed at a particular module may be performed at one or more other modules and by one or more other devices instead of or in addition to the function performed at the particular module. Further, the modules may be implemented across multiple devices or other components local or remote to one another. Additionally, the modules may be moved from one system and added to another system, or may be included in both system.

Rewards calculation system 120 may include a rewards module 122, a new account module 124 and an input/output module 126. Rewards module 122 may calculate a rewards score, which may be based on new financial account data received from the new account module 124 and account holder data received from the financial institution system 130.

New account module 124 may receive data from the rewards data storage 140 and/or financial institution system 130, where the received may include new financial account data, such as terms and conditions associated with a new financial account, additional fees associated with a new financial account, and/or deals, benefits, rewards, and/or promotions associated with a new financial account. Terms and conditions may include a minimum balance, a maximum balance, a late payment fee, an overlimit fee, a foreign transaction fee, a cash advance fee, balance transfer fee, an annual percentage rate (APR) for purchases, an APR for balance transfers, an APR for cash advances, an APR for overdraft protection advances, and/or a minimum interest charge. Additional fees may include, for example, annual fees, monthly fees, and/or other account fees. Deals, benefits, rewards, and/or promotions may include, for example, reward category, reward point allocation by category, reward category cap, reward expiration data, deal category, deal expiration data, benefit category, benefit expiration data, promotion category, and/or promotion expiration data.

New account module 124 may process the new financial account data and determine which new financial accounts may be available for a user. For example, based on account holder data, which may be received from the financial institution system 130, new account module 124 may determine which new financial accounts a user is pre-approved for. In another example, new account module 124 may determine which new financial accounts are desirable for the user based on account holder data received from the financial institution system, such as transaction data. Any account holder data may be used to determine which new financial accounts may be desirable for the user. In this manner, the new account module may determine a subset of new financial accounts that are relevant to the user to determine which new financial accounts to analyze in the rewards module 122.

The rewards calculation system 120 may receive data from the financial institution system 130 via the input/output module 126. Input/output module 126 may send data to and receive data from rewards data storage 140, financial institution system 130, merchant system 160, and/or user device 170.

Financial institution system 130 may include an account module 132, spend data module 134, and/or input/output module 136. Account module 132 may receive account holder data from financial institution data storage 150. Account module 132 may also receive account holder data from a third party (not shown) such as an account holder device or third-party device, which may include a fax, scanner, camera, and/or personal computing device. Account holder data may include account holder name, age, gender, home address, home telephone number, occupation, work address, work telephone number, household income, salary, and identification number, such as a social security number. Account holder data may also include transaction data for purchase history; which may include for example, merchant name, merchant location, merchant category, transaction amount, and transaction date; other account debits; account credits, account balance; and/or other account-related data. Account module 132 may also cleanse and transform the account holder data, if so required by the financial institution or desired by the account holder so that no personally identifiable account holder data is transmitted to the reward calculation system.

Spend data module 134 may receive account holder data from the account module 132 and categorize the data. For example, spend data module 134 may perform a preliminary categorization of account holder transaction data into various spend categories, such as transportation, bills, business-related, clothing, education, entertainment, food and/or dining, gifts, health, home, investing, childcare, loans, pet care, taxes, travel, and other. Input/output module 136 may send data to and receive data from the rewards calculation system 120, financial institution data storage 150, merchant system 160, and/or user device 170.

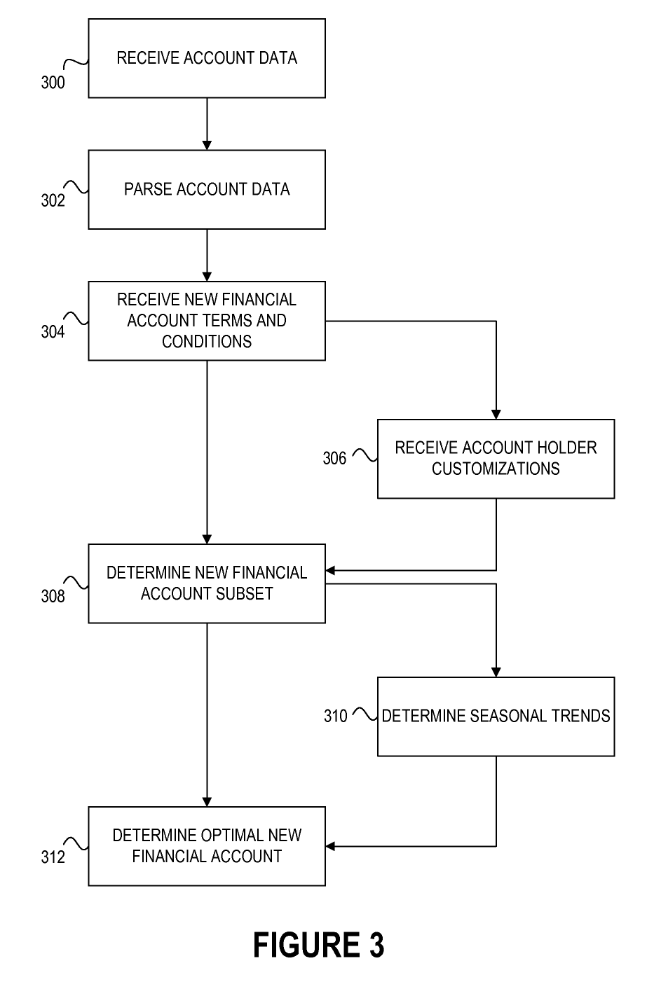

FIG. 3 illustrates an example embodiment of a method of rewards calculation for a new financial account. The method may begin at step 300 where account holder data is received at the account module 132 of the financial institution system 130. The account holder data may be received from financial institution data storage 150. From the account module 132, the data may then be sent to and parsed in the spend data module 134 of the financial institution system 130. The spend module 134 may parse out account holder identification information if required by the financial institution and/or requested by the account holder. Additional spend module 134 may categorize the account data into various spend categories. The spend categories may be determined by the spend module 134 and/or may be based on input from the new account module 124 of the rewards calculation system 120, which may provide categorical information relating to categories of new financial accounts.

At step 304, the account holder data may be sent to the rewards calculation system 120 and the rewards calculations system 120 may receive account terms and conditions for new financial account(s) from then rewards data storage 140 and/or financial institution data storage 150.

At step 308, the new account module 124 and/or the rewards module 122 may receive account holder customizations. Account holder customizations may include deleting specified transactions in the transaction data of the account holder data. According, if the account holder recently made a large one-time purchase and would not like that transaction to be included in determining an optimal new financial account, the account holder is able to remove the transaction from consideration. Account holder customizations may also include selecting an upcoming life event, such as planning a wedding, purchasing a first home, purchasing a new home (not first home), purchasing a second home, planning home renovations, the birth/adoption of a first child, the birth/adoption of a child (not first child), planning a vacation, saving for college or graduate school, attending college or graduate school, purchasing a new car, providing eldercare, adoption of a first pet, and/or adoption of a pet (not first pet). In selecting an upcoming life event, the rewards module 122 may base the determination of the optimal new financial account on average spending associated with financial accounts where the account holders also encountered the selected life event. In this manner, the determination of an optimal new financial account may take into consideration spending that the account hold may incur based on what the average account holder incurred when facing a particular life event. Account holder customizations may further include selecting a particular account holder preference. An account holder preference may include desiring terms and conditions similar to terms and conditions of an existing account of the account holder, desiring a particular financial institution to house the new financial account, a desired time frame of analysis in determining spending patterns and categories for use in determining an optimal new financial account, a desired pre-authorized credit limit for a new financial account, a desired APR range for a new financial account, a desired rewards type (e.g., airline, hotel, points, and the like), and/or a desired total fee range, where a total fee includes any yearly fees, monthly fees, and the like.

At step 308, the new account module 124 may determine a subset of new financial accounts based on the account holder data and the new financial account terms and conditions. This subset may include new financial accounts for which a user may be preapproved, new financial accounts relevant to spend categories associated with the account holder data, and/or new financial accounts related to a user customization selections from step 306. Where the subset is selected as a subset for which a user may be preapproved, the reward calculation system 120 and/or the financial institution system may transmit account holder data over network 110 to a credit bureau (not pictured) for preapproval of financial accounts.

At step 310, the rewards module 122 may determine seasonal trends based on the received account holder data. For example, the rewards module 122 may determine a seasonal trend for gasoline purchases indicating more gasoline purchases in the summer. As another example, the rewards module may determine a seasonal trend for clothing purchases indicating more clothing purchases during certain months of the year. Additionally, the financial institution system 130, in the account module 132, may determine average seasonal trend data at step 310 based on a subset of account holder data. The subset of account holder data may be determined based on demographic data, such as, age, gender, home address, home telephone number, occupation, work address, work telephone number, household income, and/or salary. By way of example, the average seasonal trend data may indicate that on average, account holders spend more money on travel during certain months of the year. As another example, the average seasonal trend data may indicate that on average, account holders spend more money on home improvement costs during certain seasons of the year. The seasonal trend data and/or average seasonal trend data may then be used in the rewards module to determine an optimal new financial account at step 312.

At step 312, the rewards module 122 may determine an optimal new financial account for a user based on the user's account holder data that has been parsed and processed, the account holder customizations, the determined seasonal trends, and/or the new financial account terms and conditions for the new financial accounts in the determined subset. The rewards module 122 may determine an optimal new financial account by calculating a rewards earned for the user based on the user's account holder data, such as transaction data, for a previous time period, such as the past month, the past X amount of months, the past year, the past X amount of years, or another user-selected time period. The rewards earned may be calculated for each of the new financial accounts in the new financial account subset.

In basing the rewards earned off of a user's account holder data, account holder customizations, new financial account data, and/or seasonal trends, the rewards, deals, benefits, and/or promotions earned may reflect all terms and conditions of the new financial account such as a minimum balance, a maximum balance, a late payment fee, an overlimit fee, a foreign transaction fee, a cash advance fee, balance transfer fee, an annual percentage rate (APR) for purchases, an APR for balance transfers, an APR for cash advances, an APR for overdraft protection advances, and/or a minimum interest charge; additional fees of the new financial account such as, annual fees, monthly fees, and/or other account fees; and/or deals, benefits, rewards, and/or promotions of the new financial account, such as reward category, reward point allocation by category, reward category cap, reward expiration data, deal category, deal expiration data, benefit category, benefit expiration data, promotion category, and/or promotion expiration data as each data for the new financial account pertains to the account holder data.

By way of example, where a user spends a large portion of the user's budget on gasoline purchases and grocery purchases, the user may be inclined to select a first new financial account where the user may receive three points for gasoline purchases, two points for grocery purchases, and one point for all other purchases. However, if that first new financial account includes a cap on the amount of spending associated with each of those spend categories, such as a $1,000 cap for the gasoline and grocery purchases, but the use spends over the cap in each category, it may be more beneficial for the user to select a second new financial account associated with a percentage of cash back on all gasoline and/or grocery purchases with a $2,000 cap. In this example, the second new financial account may provide the user with greater savings and/or rewards associated with the user's account holder data.

Additionally, the subset of new financial account may be compared against one another and the comparison may be sent to a user device 170 for review by the user. Accordingly, the user may select a particular account based on the comparison using the user device 170. Once a user has selected a particular account, the rewards calculation system 120 and/or financial institution system 130 may transmit the user's account holder data to the proper credit bureau and financial institution associated with the new financial account for approval of the new financial account.

FIG. 4 illustrates an example embodiment of calculating rewards for existing accounts. At step 400, the method begins with receiving account data at the account module 132 of the financial institution system 130. The account holder data may be received from financial institution data storage 150. From the account module 132, the data may then be sent to and parsed in the spend data module 134 of the financial institution system 130 at step 402. The spend module 134 may parse out account holder identification information if required by the financial institution and/or requested by the account holder. Additional spend module 134 may categorize the account data into various spend categories. The spend categories may be determined by the spend module 134 and/or may be based on input from the rewards calculation system 120, which may provide categorical information relating to categories of financial accounts.

At step 404, the account holder data may be sent to the rewards calculation system 120 and the rewards calculations system 120 may receive account terms and conditions for existing financial account(s) associated with the account holder from then rewards data storage 140 and/or financial institution data storage 150. At step 406, transaction data may be received from the merchant system 160 at the rewards calculation system 130. Transaction data may include, merchant name, merchant location, merchant category, transaction amount, transaction date, and/or good and/or service to be purchased.

At step 408, the rewards module 122 may receive account holder customizations. Account holder customizations may further include selecting a particular account holder preference. An account holder preference may include desiring to acquire a certain type of reward, deal, promotion, and/or offer (e.g., airline miles, hotel points, general points, and the like), desiring to use an account associated with a particular financial institution, a desired APR range, and/or a desired total fee range, where a total fee includes any yearly fees, monthly fees, and the like.

At step 410, the rewards module 122 may determine a subset of existing financial accounts based on the account holder customizations and/or transaction data. At step 412, the system 100 may determine an optimal financial account to use for a particular transaction based on user's account holder data that has been parsed and processed, the account holder customizations, the transaction data, and/or the new financial account terms and conditions for the existing financial accounts. In this manner, the rewards calculation system 120 may determine whether a particular financial account associated with a particular reward has hit a cap on the reward and will thus, no longer provide the rewards for that category as it does when the cap is not yet reached. Additionally, the rewards calculation system 120 may determine how to achieve optimal rewards, deals, offers, and/or promotions for a particular account holder on a transaction by transaction basis.

It is further noted that the systems and methods described herein may be tangibly embodied in one of more physical media, such as, but not limited to, a compact disc (CD), a digital versatile disc (DVD), a floppy disk, a hard drive, read only memory (ROM), random access memory (RAM), as well as other physical media capable of storing software, or combinations thereof. Moreover, the figures illustrate various components (e.g., servers, computers, processors, etc.) separately. The functions described as being performed at various components may be performed at other components, and the various components bay be combined or separated. Other modifications also may be made.

In the preceding specification, various preferred embodiments have been described with references to the accompanying drawings. It will, however, be evident that various modifications and changes may be made thereto, and additional embodiments may be implemented, without departing from the broader scope of the invention as set forth in the claims that follow. The specification and drawings are accordingly to be regarded as an illustrative rather than restrictive sense

We claim:

1. A system comprising:
a database that stores account holder data and account holder terms and conditions data, wherein the account holder terms and conditions data is associated with a particular financial account;
a communication interface that receives account holder data and potential terms and conditions data, wherein the potential terms and conditions data are terms and conditions for a plurality of potential other accounts;
a rewards processor that determines a subset of the potential other accounts based on the received account holder data and the received potential terms and conditions data and determines at least one optimal new financial account from the subset of potential account holder accounts based on the received account holder data and the received potential terms and conditions data;
a rewards presentation interface that transmits information about the subset of the potential other accounts and the identification of the at least one optimal new financial account to a user.

2. The system of claim 1, wherein the information about the subset of the potential other accounts and the identification of the at least one optimal new financial account provides a comparison of the terms and conditions for the respective plurality of other accounts and terms and conditions of the at least one optimal new financial account.

3. The system of claim 1, wherein the determination of the at least one optimal new financial account is based on rewards information associated with the respective terms and conditions for a plurality of potential other accounts.

4. The system of claim 3, wherein the rewards information includes spending caps associated with respective spend categories.

5. The system of claim 3, wherein the rewards information includes annual fees associated with the respective plurality of potential other accounts.

6. The system of claim 1, wherein the particular financial account is associated with a first financial institution and the plurality of potential other accounts are associated with a respective plurality of other financial institutions.

7. The system of claim 1, wherein the account holder terms and conditions includes spending caps associated with respective spend categories.

8. The system of claim 1, wherein the account holder terms and conditions includes an annual fee for the particular financial account.

9. The system of claim 1, further comprising:
an account selection processor that enables the user to select the at least one optimal new financial account and automatically establishes the at least one optimal new financial account.

10. The system of claim 9, wherein the communication receives user selection information indicating that the user has selected the at least one optimal new financial account.
